(19) United States
(12) Patent Application Publication
(10) Pub. No.: US 2024/0298847 A1
(43) Pub. Date: Sep. 12, 2024

(54) Multi-Purpose Grill Accessory

(71) Applicant: Ryan Bricker, Dallas, TX (US)

(72) Inventor: Ryan Bricker, Dallas, TX (US)

(21) Appl. No.: 18/639,248

(22) Filed: Apr. 18, 2024

Related U.S. Application Data
(63) Continuation-in-part of application No. 29/886,545, filed on Mar. 9, 2023.
(60) Provisional application No. 63/460,066, filed on Apr. 18, 2023.

(51) Int. Cl. A47J 43/28; A47J 37/07; B67B 7/16; F21V 33/00

(52) U.S. Cl. CPC A47J 43/288; A47J 37/0786; A47J 43/283; B67B 7/16; F21V 33/0084

(57) ABSTRACT

In at least one embodiment, a grilling apparatus comprises a body, spatula, tongs, and a utility element. The spatula is configured to fold on top of the body at a rotating joint. The tongs are configured to insert into the body. The top and bottom grips of the tongs are configured to align with the top and bottom grips of the body when the tongs are inserted into the body. The utility element can be a flask configured to be positioned between the slats of the tongs when inserted into the body and to store fluids or seasonings. The utility element can be a flashlight configured to be positioned at the first end of the body.

### CROSS-REFERENCE TO RELATED APPLICATIONS

This application, which claims the benefit of U.S. Provisional Application No. 63/460,066, filed Apr. 18, 2023, is a continuation-in-part application of co-pending U.S. patent application Ser. No. 29/886,545, filed Mar. 9, 2023, the disclosures of which are incorporated herein by reference in their entirety.

### BACKGROUND

### Technical Field

The present disclosure relates to grill accessories. More particularly, and not by way of limitation, the present disclosure is directed to a grilling apparatus that combines a spatula, tongs, and a flask.

### Description of Related Art

This background section is intended to provide a discussion of related aspects of the art that could be helpful in understanding the embodiments discussed in this disclosure. It is not intended that anything contained herein be an admission of what is or is not prior art, and accordingly, this section should be considered in that light.

Grilling requires the use of instruments to flip and position foods for proper cooking. While many grilling instruments are specialized and properly designed for their intended tasks, the proliferation of instruments considered indispensable for grilling requires additional space to store those instruments.

It would be advantageous to have a grilling apparatus that overcomes the disadvantages of the prior art.

### BRIEF SUMMARY

This summary provides a discussion of aspects of certain embodiments of the invention. It is not intended to limit the claimed invention or any of the terms in the claims. The summary provides some aspects, but there are aspects and embodiments of the invention that are not discussed here.

In at least one embodiment, a grilling apparatus comprises a body, spatula, tongs, and a utility element. The spatula is configured to fold on top of the body at a rotating joint. The tongs are configured to be inserted into the body. The top and bottom grips of the tongs are configured to align with the top and bottom grips of the body when the tongs are inserted into the body.

In one aspect, the utility element is a flask configured to be positioned between the slats of the tongs when inserted into the body and to store fluids or seasonings.

In another aspect, the utility element is a flashlight configured to be positioned at a first end of the body.

In yet another aspect, the grilling apparatus comprises a flask and a flashlight. The flask being configured to be positioned between the slats of the tongs when inserted into the body and to store fluids or seasonings. The flashlight being configured to be positioned at a first end of the body.

### BRIEF DESCRIPTION OF THE DRAWINGS

The novel features believed characteristic of the disclosure are set forth in the appended claims. The disclosure itself, however, as well as a preferred mode of use, further objectives, and advantages thereof, will be best understood by reference to the following detailed description of illustrative embodiments when read in conjunction with the accompanying drawings, wherein:

FIG. 1A is an illustration of a grilling apparatus with an unfolded spatula;

FIG. 1B is an illustration of a grilling apparatus from an exploded view;

FIG. 1C is an illustration of a grilling apparatus with a folded spatula from a top view;

FIG. 1D is an illustration of a grilling apparatus with a folded spatula from a first side view;

FIG. 1E is an illustration of a grilling apparatus with a folded spatula from a second side view;

FIG. 2A is an illustration of an alternative embodiment of a grilling apparatus with a folded spatula from a first side view;

FIG. 2B is an illustration of an alternative embodiment of a grilling apparatus from an exploded view; and

FIG. 2C is an illustration of an alternative embodiment of a grilling apparatus from another exploded view.

### DETAILED DESCRIPTION

Grilling is the action of cooking food over a grill. The most commonly used instruments in most grilling applications are the spatula and the tongs. A spatula is a cooking utensil characterized by a flat surface attached to a handle. A user grasps the handle to position the flat surface beneath the food. Once underneath, the user is capable of turning, lifting, flipping, or otherwise positioning food. Alternatively, a spatula can be used to press food into a grill's surface-most commonly used to increase the heat transfer from the grill's surface to the food. Tongs are similarly used for food positioning but instead are characterized by two slats or grips hinged at the end or in the middle. A user grasps the two slats and closes the slats together to grip food between the slats. Combined, these two utensils allow a user to accurately maneuver, place, and remove most solid types of food on a grilling surface. However, a common issue for many users is the proliferation of cooking utensils taking up valuable space in a kitchen or cooking area. Therefore, there exists a need to provide the two most commonly used grilling utensils in a space-saving configuration.

Beyond merely placing and positioning food for cooking, grilling often involves seasoning the food to improve the flavor. Many different types of sauces exist for many different types of food. Because sauces are only used occasionally and are not often consumed directly, they are often stored in less commonly accessed areas, such as behind commonly used seasonings in a drawer, for example. This arrangement contributes to users forgetting that sauces are available for flavoring food when grilling. Therefore, there also exists a need to store sauces in a visible, easily accessible location that users will be reminded of when grilling.

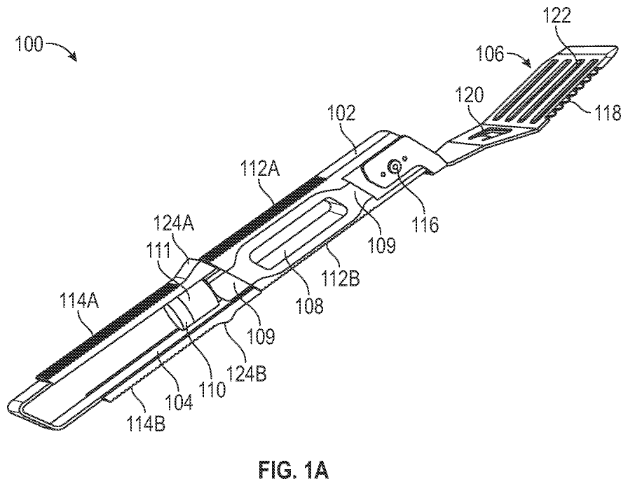

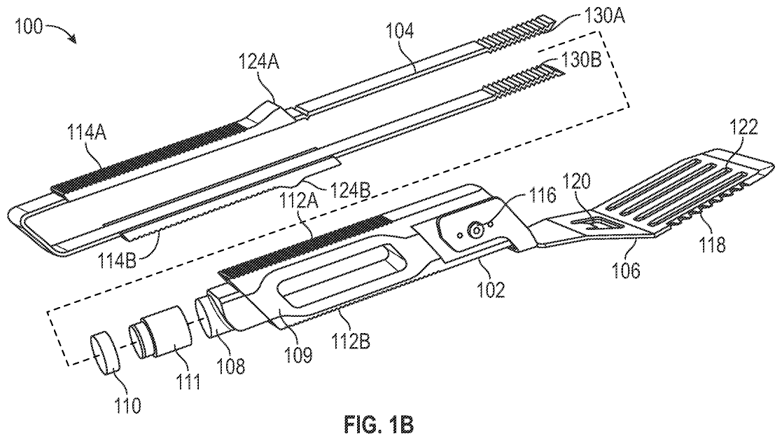

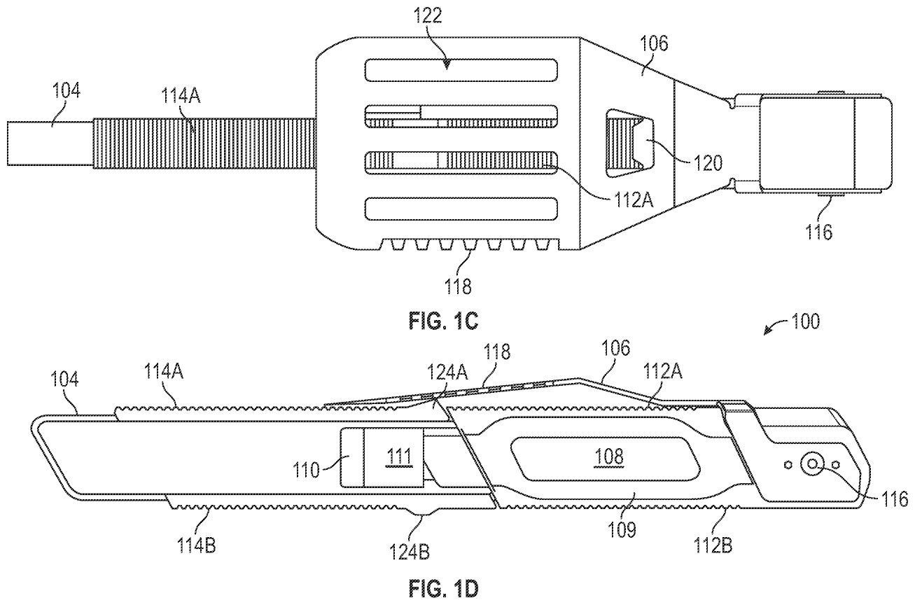

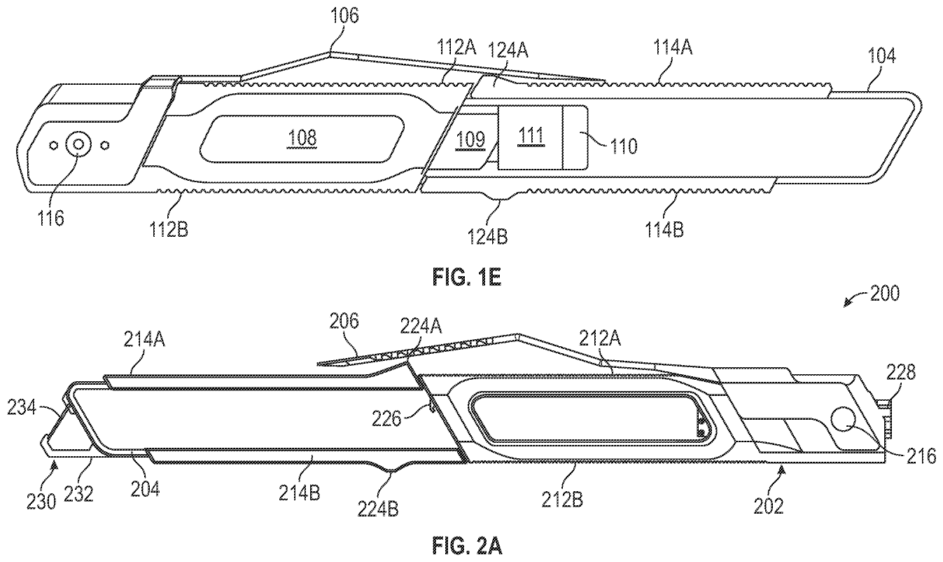

An embodiment of the disclosure will be described. FIGS. 1A-1E (collectively FIG. 1) depict an illustration of a grilling apparatus 100. The grilling apparatus 100 comprises a body 102, tongs 104, a spatula 106, and a flask 108. The slats 105 of the tongs 104 are inserted in the body 102 such that the tongs 104 are configured to remain secured inside of the body 102 unless removed. The flask 108 is fixed within the body 102 and positioned between the slats 105 of the tongs 104 when the tongs 104 are inserted into the body 102, such that the contents of the flask are accessible while the tongs are inserted into the body. The spatula 106 is affixed to the body 102 via a rotating joint 116. The spatula 106 is configured to rotate at the joint 116 to fold over atop the body 102 for compact storage and to unfold for use. The flask 108 is configured to store liquids, seasonings, or other contents within. Combined, the grilling apparatus 100 provides a spatula, tongs, and a flask in a single apparatus-arguably the three most useful utensils for grilling.

In some examples, the body 102 comprises a generally rectangular shape. The body 102 is designed to function as a grip for a user's hand when the tongs 104 are removed from the body 102. The grilling apparatus 100 is sized to allow a user to hold the body 102 in the palm of the user's hand. The body 102 can comprise a uniform material or can be comprised of a plurality of materials. In some examples, the body 102 comprises a soft thermoplastic.

As shown in at least FIG. 1A, the body 102 of the grilling apparatus 100 can include a top grip 112A and a bottom grip 112B. These grips can be any type of surface configured to improve a user's grip on the body 102 during operation. In some examples, the grips are corrugations, alternating bumps, divots, or some other disruption in the surface of the body 102. Positioning the top grips 112A and bottom grips 112B on opposing faces of the body 102 further improves a user's grip on the body 102 during operation.

The spatula 106 of the grilling apparatus 100 can comprise one or more openings 122 on a flat face of the spatula 106. The openings 106 are designed to allow for small contents and fluids to fall through the openings while positioning an object atop the face of the spatula 106. In addition, the spatula can comprise a tab 120 configured to function as a bottle opener. The spatula 106 can also comprise cutting teeth 118. The cutting teeth 118 allow a user to cut foods without switching to a different instrument, furthering grilling efficiency and ease of use.

The flask 108 can be encased inside a flask body 109. The flask 108 may be made from any suitable material for storing fluids or seasonings, such as glass or plastic. The flask body 109 may be the same material as the body 102. In at least one embodiment, the body 102 and the flask body 109 contain openings on at least one side of the grilling apparatus 100, allowing for a user to visibly inspect the flask 108. If the flask is made of transparent material, then a user can visibly inspect flask 108 and detect its contents.

A cap 111 can be configured to removably couple an open end of the flask 108, thereby forming a seal. Cap 111 can comprise an opening configured to allow fluids within flask 108 to flow out of the cap through the opening. A cap seal 110 can be configured to removably couple an end of the cap 111 to prevent liquid from exiting through the opening, thereby forming an additional seal. In at least one embodiment, the cap seal 110 is configured to couple the cap 111 via threads. The cap 111 and the cap seal 110 may be formed out of a metal, such as aluminum.

The tongs 104 can comprise two slats 105, a top grip 114A, and a bottom grip 114B. The tongs 104 are configured to removably couple to the body 102 by sliding the two slats 105 into openings in the body 102. Furthermore, the tongs 104 can comprise top teeth (130A in FIG. 1B) and bottom teeth (130B in FIG. 1B, collectively “teeth 130”) embedded on the ends of the two slats 105. The top grip 114A can include a first finger rest 124A, and the bottom grip 124B can include a second finger rest 124B. As depicted in FIG. 1A, finger rests 124A and 124B can include outward-facing protrusions. These protrusions are configured to provide an angled contact point for a user's fingers to rest while operating the tongs 104. In at least one example, the top grip 114A and bottom grip 114B align with the top grip 112A and bottom grip 114B, respectively, when the tongs 104 are inserted into the body, forming a continuous grip.

As shown in FIG. 1B, the tongs 104 of the grilling apparatus 100 can be removed from the body 102. When removed, a user can hold the grilling apparatus 100 in two hands, allowing for more precise positioning and manipulation of food to be grilled. The teeth 130 of the tongs 104 can be embedded on the ends of the tongs 104 on at least an inward-facing side but may also be embedded on an outward-facing side as well. The teeth enhance the grip by collapsing the two slats 105 of the tongs 104 together, sandwiching an object in between.

As shown in FIG. 1C-E, the spatula 106 can rotate via the rotating joint 116 to fold on top of the top side of the grilling apparatus 100. This folding feature improves the ease of storage because the grilling apparatus compacts into a smaller size.

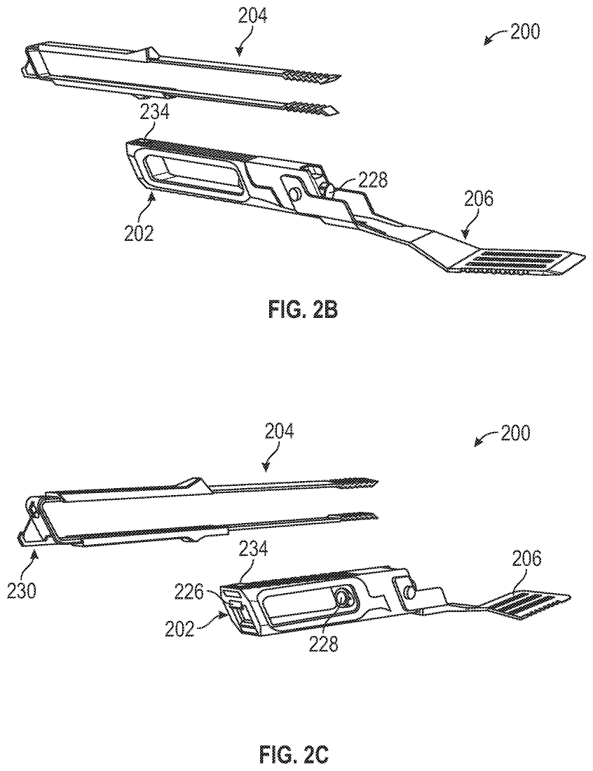

Turning to FIGS. 2A-2C, an alternative embodiment of a grilling apparatus 200 is shown. Grilling apparatus 200 includes body 202, tongs 204, and spatula 206. The slats 205 of tongs 204 are configured to be inserted in body 202 such that tongs 204 remain secured inside body 202. In the illustrative embodiment, body 202, tongs 204, and spatula 206 have the same general shape and configuration as body 102, tongs 104, and spatula 106 depicted in FIGS. 1A-1E and described above.

Tongs 204 can have an identical configuration as spatula 104 described above. For example, tongs 204 can have two slats 205, a top grip 214A, and a bottom grip 214B. Tongs 204 are configured to removably couple to body 202 by sliding the two slats 205 into openings in body 202. Furthermore, tongs 204 can comprise top and bottom teeth embedded on the ends of the slats 205. The top grip 214A can include a first finger rest 224A, and the bottom grip 224B can include a second finger rest 224B. Finger rests 224A and 224B can include outward-facing protrusions configured to provide an angled contact point for a user's fingers to rest while operating tongs 204. In at least one example, the top grip 214A and bottom grip 214B align with the top grip 212A and bottom grip 214B, respectively, when tongs 204 are inserted into body 202, forming a continuous grip.

Tongs 204 can remain secured within body 202 via a release button 234 formed in the top portion of body 202 at the second end. In the illustrative embodiment, when tongs 204 are inserted into body 202, release button 234 selectively engages tongs 204. To remove tongs 204 from body 202, release button 234 is pressed, unengaging tongs 204. Tongs 204 may also include carabiner 230 disposed on a proximate end. Carabiner 230 may include hook 230 and latch 234.

Body 202 also includes a flashlight 228 fixed within body 202 and positioned at the first end of body 202. In an alternative embodiment, flashlight 228 can be fixed within body 202 and positioned at a second, opposite end of body 202. Grilling apparatus 200 is configured such that the light emitted from flashlight 228 is visible when spatula 206 is in a closed position (e.g., FIG. 2A) or an open position (e.g., FIGS. 2B and 2C). This configuration is advantageous because it allows a user to use flashlight 228 while cooking or grilling. Additionally, the configuration advantageously allows a user to use grilling apparatus 200 as a general flashlight when spatula 206 is in the closed position.

In some examples, body 202 comprises a generally rectangular shape. Body 202 is designed to function as a grip for a user's hand when tongs 204 are removed from body 202. Grilling apparatus 200 is sized to allow a user to hold body 202 in the palm of the user's hand. Body 202 can comprise a uniform material or can be comprised of a plurality of materials. In some examples, body 202 comprises a soft thermoplastic. Body 202 can also include bottle opener 226 disposed on the second side of body 202.

As shown in FIG. 2A, body 202 can include a top grip 112A and a bottom grip 112B. These grips can be any type of surface configured to improve a user's grip on body 202 during operation. In some examples, the grips are corrugations, alternating bumps, divots, or some other disruption in the surface of body 202. Positioning the top grips 112A and bottom grips 112B on opposing faces of body 202 further improves a user's grip on body 202 during operation.

Spatula 206 can have an identical configuration as spatula 106 described above. For example, spatula 206 can have one or more openings on a flat face of spatula 206. The openings are designed to allow small contents and fluids to fall through the openings while positioning an object atop the face of the spatula 206. In addition, the spatula can optionally comprise a tab configured to function as a bottle opener. Spatula 206 can also comprise cutting teeth that allow a user to cut foods without needing to switch to a different instrument, furthering grilling efficiency and ease of use.

Spatula 206 can rotate around the first end of body 202 via rotating joint 216 to fold on top of body 202 (i.e., closed position). This folding feature improves the ease of storage because the grilling apparatus compacts into a smaller size.

While this disclosure has been particularly shown and described with reference to preferred embodiments, it will be understood by those skilled in the art that various changes in form and detail may be made therein without departing from the spirit and scope of the invention. The investors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only and not limitation. Thus, the breadth and scope of this disclosure should not be limited by any of the above-described exemplary embodiments but should be defined only in accordance with any claims and their equivalents issuing from this disclosure. Furthermore, the above advantages and features are provided in described embodiments but shall not limit the application of such issued claims to processes and structures accomplishing any or all of the above advantages.

Additionally, the section headings herein are provided for consistency with the suggestions under 37 C.F.R. § 1.77 or to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that a particular technology is prior art to any embodiment(s) in this disclosure. Neither is the “Summary” a characterization of the embodiment(s) outlined in issued claims.

Furthermore, any reference in this disclosure to “invention” in the singular should not be used to argue that there is only a single point of novelty in this disclosure. Multiple embodiments may be set forth according to the limitations of the multiple claims issuing from this disclosure. Such claims accordingly define the embodiment(s) and their equivalents that are protected thereby. In all instances, the scope of such claims shall be considered on their own merits in light of this disclosure but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the preceding Detailed Description, it can be seen that various features may be grouped in a single embodiment to streamline the disclosure. This method of disclosure is not to be interpreted as reflecting an intention that the claimed embodiments require more features than are expressly recited in each claim. Instead, as the claims reflect, the inventive subject matter lies in less than all features of a single disclosed embodiment. Thus, the following claims are incorporated into the Detailed Description, with each claim standing on its own as a separate embodiment.

What is claimed is:

1. A grilling apparatus comprising:
a body comprising a top grip and a bottom grip;
a spatula rotatably coupled to the body via a rotating joint, wherein the spatula is configured to rotate between an open position and a closed position;
tongs comprising a top grip and a bottom grip, wherein the tongs are configured to insert into the body, the top and bottom grips of the tongs aligning with the top and bottom grips of the body when the tongs are inserted into the body; and
a utility element fixed within the body.

2. The grilling apparatus of claim 1, wherein the utility element is a flashlight, and wherein the flashlight is positioned at a first end of the body.

3. The grilling apparatus of claim 1, wherein the utility element is a flask, further wherein the flask positioned between slats of the tongs when the tongs are inserted into the body, and further wherein the contents in flask are accessible while the tongs are inserted into the body.

4. The grilling apparatus of claim 2, wherein light emitted from the flashlight is visible when the spatula is in the open position and the closed position.

5. The grilling apparatus of claim 1, wherein the body comprises a release button, the release button configured to selectively engage the tongs when the tongs are inserted into the body.

6. The grilling apparatus of claim 2, wherein the body comprises a release button, the release button configured to selectively engage the tongs when the tongs are inserted into the body.

7. The grilling apparatus of claim 1, wherein the tongs comprise a carabiner disposed on a proximate end.

8. The grilling apparatus of claim 2, wherein the flashlight is permanently secured to the body.

9. The grilling apparatus of claim 2, wherein the flashlight is removably secured to the body.

10. The grilling apparatus of claim 2, wherein the tongs comprise a carabiner disposed on a proximate end.

11. The grilling apparatus of claim 1, wherein the body comprises a bottle opener disposed on a second end of the body.

12. The grilling apparatus of claim 2, wherein the body comprises a bottle opener disposed on a second end of the body.
